(19) United States
(12) Patent Application Publication
(10) Pub. No.: US 2018/0286060 A1
(43) Pub. Date: Oct. 4, 2018

(54) RECORDING MEDIUM RECORDING DISPLAY CONTROL PROGRAM AND DISPLAY CONTROL DEVICE

(71) Applicant: FUJITSU LIMITED, Kawasaki-shi (JP)

(72) Inventor: Taishi Someya, Kawasaki (JP)

(73) Assignee: FUJITSU LIMITED, Kawasaki-shi (JP)

(21) Appl. No.: 15/896,294

(22) Filed: Feb. 14, 2018

(30) Foreign Application Priority Data
Mar. 30, 2017 (JP) 2017-068217

(51) Int. Cl. G06T 7/50; G01B 11/24; G01B 11/02; H04N 5/335; H04N 5/77; H04N 1/00; H04N 7/04; G06K 7/14

(52) U.S. Cl. CPC G06T 7/50; G01B 11/24; G01B 11/022; G06K 7/146; H04N 5/772; H04N 1/00904; H04N 7/04; H04N 5/335

(57) ABSTRACT

A non-transitory computer-readable recording medium recording a display control program which makes a processor operations of: obtaining image information imaged by an imaging circuit; determining whether or not a given shape is included in the obtained image information; outputting an instruction to increase processing power of the processor when the given shape is included; referring to a first storage configured to store a plurality of reference images, and determining whether or not the plurality of reference images include a reference image corresponding to an image inside the given shape; when the reference image corresponding to the image inside the shape is included, referring to a second storage configured to store an object in association with the reference image, and identifying the object associated with the reference image corresponding to the image inside the shape; and displaying the identified object on a display.

### CROSS-REFERENCE TO RELATED APPLICATION

This application is based upon and claims the benefit of priority of the prior Japanese Patent Application No. 2017-68217, filed on Mar. 30, 2017, the entire contents of which are incorporated herein by reference.

### FIELD

The embodiments discussed herein are related to a recording medium on which a display control program is recorded and a display control device.

### BACKGROUND

In a portable terminal device, the operating frequency of a central processing unit (CPU) is suitably controlled according to the content of processing to be performed.

A related technology is disclosed in Japanese Laid-open Patent Publication No. 2010-039791.

### SUMMARY

According to an aspect of the embodiments, a non-transitory computer-readable recording medium recording a display control program which makes a processor operations of: obtaining image information imaged by an imaging circuit; determining whether or not a given shape is included in the obtained image information; outputting an instruction to increase processing power of the processor when the given shape is included; referring to a first storage configured to store a plurality of reference images, and determining whether or not the plurality of reference images include a reference image corresponding to an image inside the given shape; when the reference image corresponding to the image inside the shape is included, referring to a second storage configured to store an object in association with the reference image, and identifying the object associated with the reference image corresponding to the image inside the shape; and displaying the identified object on a display.

The object and advantages of the invention will be realized and attained by mean of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of augmented reality (AR);

FIG. 2 illustrates an example of a hardware configuration of a terminal device;

FIG. 3 represents an example of a terminal device;

FIG. 4 illustrates an example of a reference marker storage unit;

FIG. 5 illustrates an example of an AR object storage unit;

FIG. 6 illustrates an example of operation of a terminal device;

FIG. 7 illustrates an example of operation of a terminal device;

FIG. 8 illustrates an example of an AR object storage unit; and

FIG. 9 illustrates an example of operation of a terminal device.

### DESCRIPTION OF EMBODIMENTS

For example, a processor such as a CPU generates heat as the processor performs processing. The processing power (for example, operating frequency) of the processor is restricted to suppress excessive heat generation. When the processing power of the processor is restricted, the performance of the processing tends to be delayed. In augmented reality (AR), for example, an AR object (for example, video contents) may not be displayed smoothly when the performance of requested high-load processing is delayed.

As an example, display control that increases the processing power of a processor before starting high-load processing may be provided.

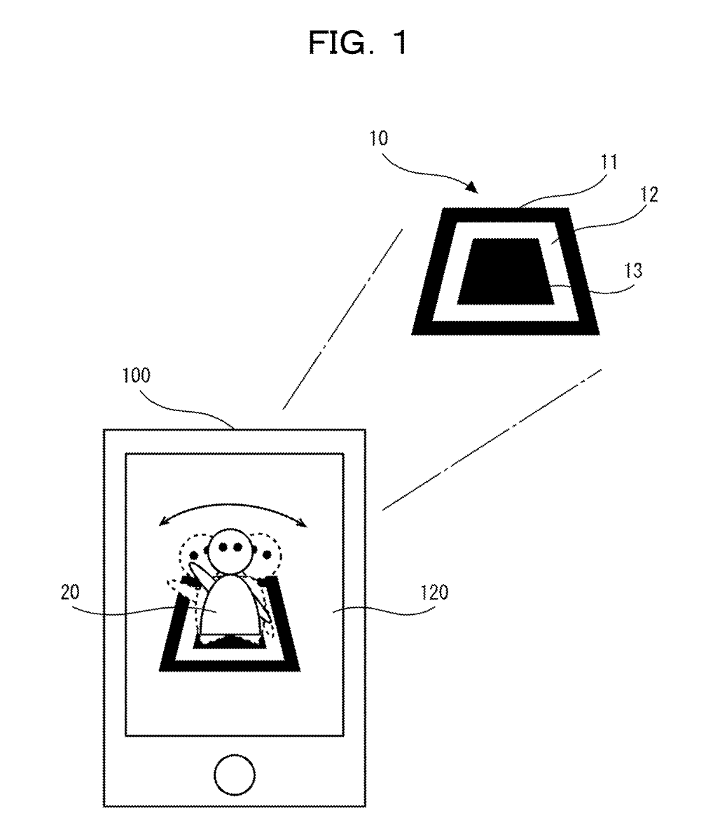

FIG. 1 illustrates an example of AR. AR is a technology that virtually sets a three-dimensional virtual space corresponding to a real space, and disposes and displays, in the virtual space, an AR object not present in the real space. As illustrated in FIG. 1, for example, a terminal device 100 as a display control device images the inside of an imaging region including an AR marker 10 present in the real space. The AR marker 10 includes a black rectangular frame (for example, a square frame) 11 and a white region 12. The white region 12 is positioned inside the rectangular frame 11. Various dot patterns 13 are rendered in the white region 12. The terminal device 100 detects the AR marker 10 based on the rectangular frame 11. When the terminal device 100 detects the AR marker 10, the terminal device 100 recognizes an image of a dot pattern 13, and dynamically displays an AR object corresponding to the recognized image in such a manner as to be superimposed on the imaged image on a display unit 120. For example, when the terminal device 100 detects the AR marker 10, the terminal device 100 dynamically displays the AR object on the display unit 120 without a user performing a special operation on the terminal device 100. In FIG. 1, video contents (for example, a moving image of a character) 20 are depicted as an example of the AR object. However, the AR object may be image contents (for example, a still image), character contents, or the like.

A smart phone is depicted as an example of the terminal device 100 in FIG. 1. However, the terminal device 100 may be a smart device such as a tablet terminal. The terminal device 100 may, for example, be a wearable device such as a head mounted display (HMD) or a smart watch.

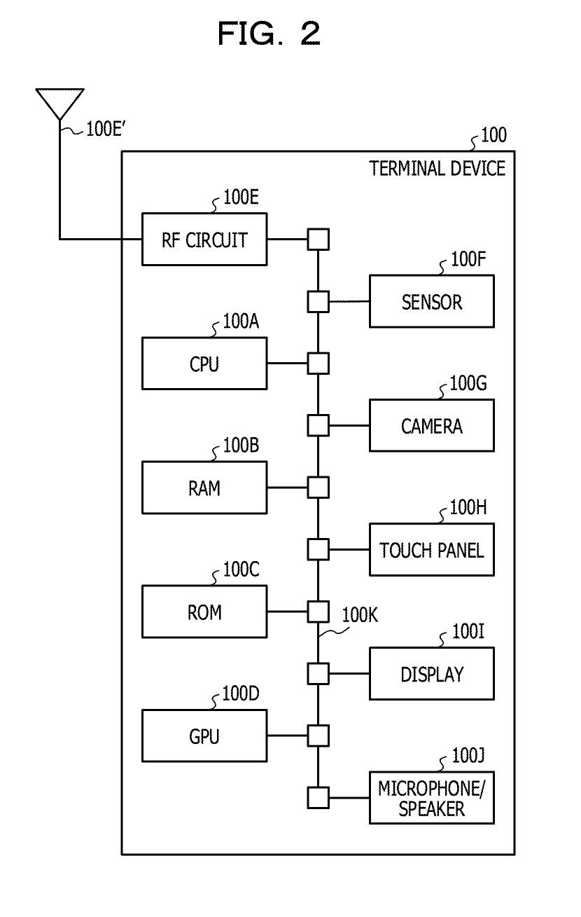

FIG. 2 illustrates an example of a hardware configuration of a terminal device. The terminal device depicted in FIG. 2 may be the terminal device 100 depicted in FIG. 1. As illustrated in FIG. 2, the terminal device 100 includes a CPU 100A, a random access memory (RAM) 100B, a read only memory (ROM) 100C, a graphics processing unit (GPU) 100D, and a radio frequency (RF) circuit 100E. An antenna 100E′ is coupled to the RF circuit 100E. A CPU implementing a communicating function may be used in place of the RF circuit 100E.

The terminal device 100 includes a sensor 100F, a camera 100G, a touch panel 100H, a display 100I, and a microphone and speaker (described as a microphone/speaker in FIG. 2) 100J. The constituent elements from the CPU 100A to the microphone and speaker 100J are coupled to each other by an internal bus 100K. At least the CPU 100A and the RAM 100B cooperate with each other to implement a computer.

In the RAM 100B, a program stored in the ROM 100C is stored by the CPU 100A. When the CPU 100A executes the stored program, various kinds of functions are implemented, and various kinds of processing are performed.

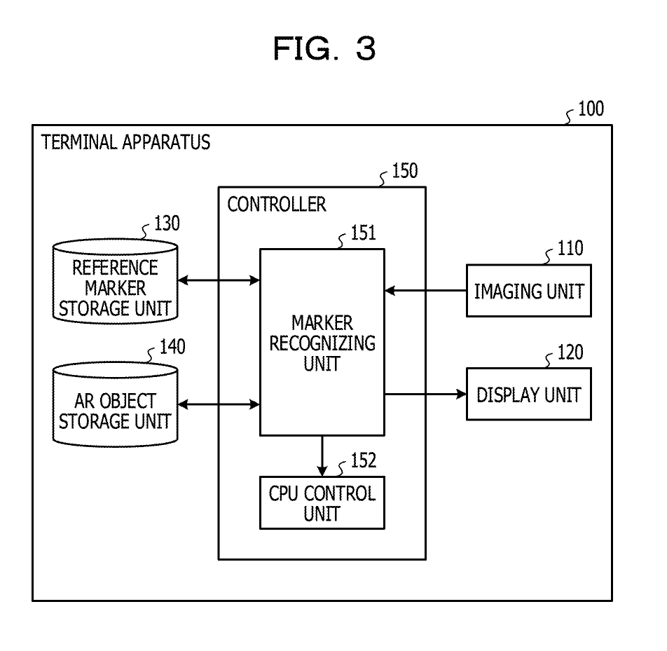

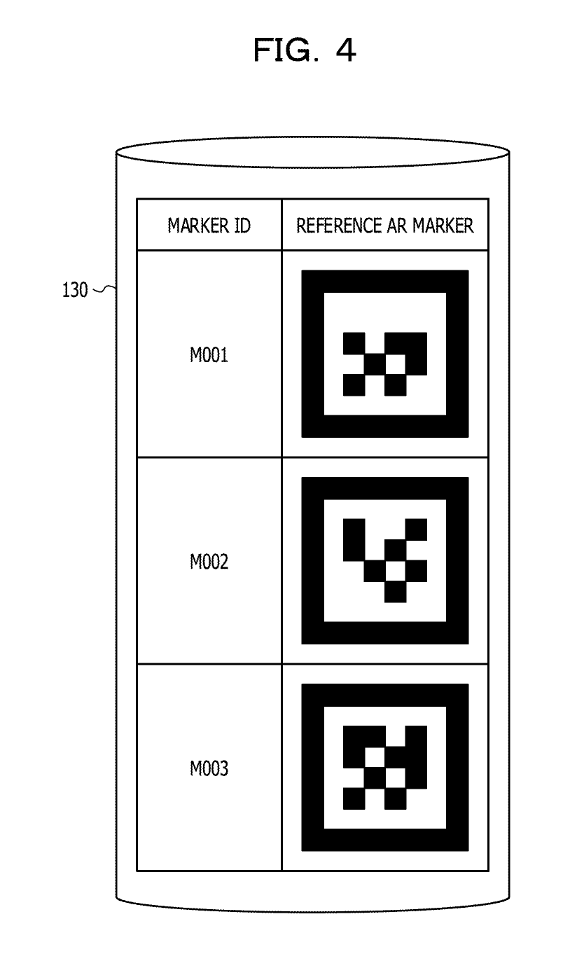

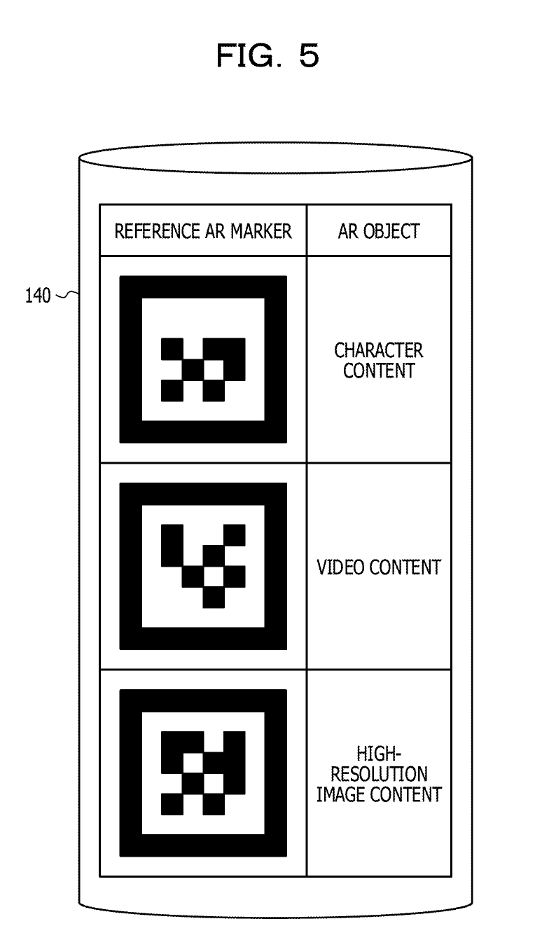

FIG. 3 illustrates an example of a terminal device. The terminal device depicted in FIG. 3 may be the terminal device 100 depicted in FIG. 1. FIG. 3 illustrates a functional configuration of the terminal device 100. FIG. 4 illustrates an example of a reference marker storage unit. FIG. 5 illustrates an example of an AR object storage unit.

The terminal device 100 includes an imaging unit 110, a display unit 120, a reference marker storage unit 130, an AR object storage unit 140, and a control unit 150. The imaging unit 110 is, for example, implemented by the camera 100G described above. The display unit 120 is, for example, implemented by the display 100I described above. The reference marker storage unit 130 and the AR object storage unit 140 are, for example, implemented by the ROM 100C described above. The control unit 150 is, for example, implemented by the CPU 100A and the GPU 100D described above.

The imaging unit 110 images the inside of the imaging region. When the imaging unit 110 images the inside of the imaging region, the imaging unit 110 generates an imaged image corresponding to the imaging region. Hence, when the AR marker 10 is included in the imaging region, an imaged image including the AR marker 10 is generated. The display unit 120 displays the imaged image. When the imaged image includes the AR marker 10, the display unit 120 displays an AR object in such a manner as to be dynamically superimposed on the imaged image including the AR marker 10.

The reference marker storage unit 130 stores a plurality of reference AR markers. The reference AR markers are images to be compared with the AR marker 10 (for example, the dot pattern 13) included in the imaged image. As illustrated in FIG. 4, the reference marker storage unit 130 stores the plurality of reference AR markers in association with marker identification (ID). The marker IDs are information identifying the reference AR markers.

The AR object storage unit 140 stores AR objects in association with the reference AR markers. As illustrated in FIG. 5, the AR object storage unit 140 stores the plurality of reference AR markers in association with the respective AR objects. As described above, there are character contents, video contents, high-resolution image contents, or the like as the AR objects.

The control unit 150 controls operation of the whole of the terminal device 100. As illustrated in FIG. 3, the control unit 150 includes a marker recognizing unit 151 and a CPU control unit 152. When the marker recognizing unit 151 obtains the imaged image from the imaging unit 110, the marker recognizing unit 151 determines whether or not the obtained imaged image includes a rectangular frame 11. When the obtained imaged image includes a rectangular frame 11, the marker recognizing unit 151 outputs an instruction to increase the processing power of the control unit 150 (which instruction will hereinafter be referred to as an increasing instruction) to the CPU control unit 152. The marker recognizing unit 151 outputs an instruction to decrease the processing power of the control unit 150 (which instruction will hereinafter be referred to as a decreasing instruction) to the CPU control unit 152 when an AR application is started, image recognition for the dot pattern 13 is ended, or display of a high-load AR object is ended. The marker recognizing unit 151 performs various other kinds of information processing.

The CPU control unit 152 controls the processing power of the control unit 150. For example, the CPU control unit 152 increases or decreases the operating frequency (or clock frequency) of the control unit 150 based on the increasing instruction or the decreasing instruction output from the marker recognizing unit 151. The CPU control unit 152 may, for example, increase or decrease the number of cores of the control unit 150 being used based on an instruction output from the marker recognizing unit 151. Incidentally, the CPU control unit 152 may control both the operating frequency of the control unit 150 and the number of cores of the control unit 150.

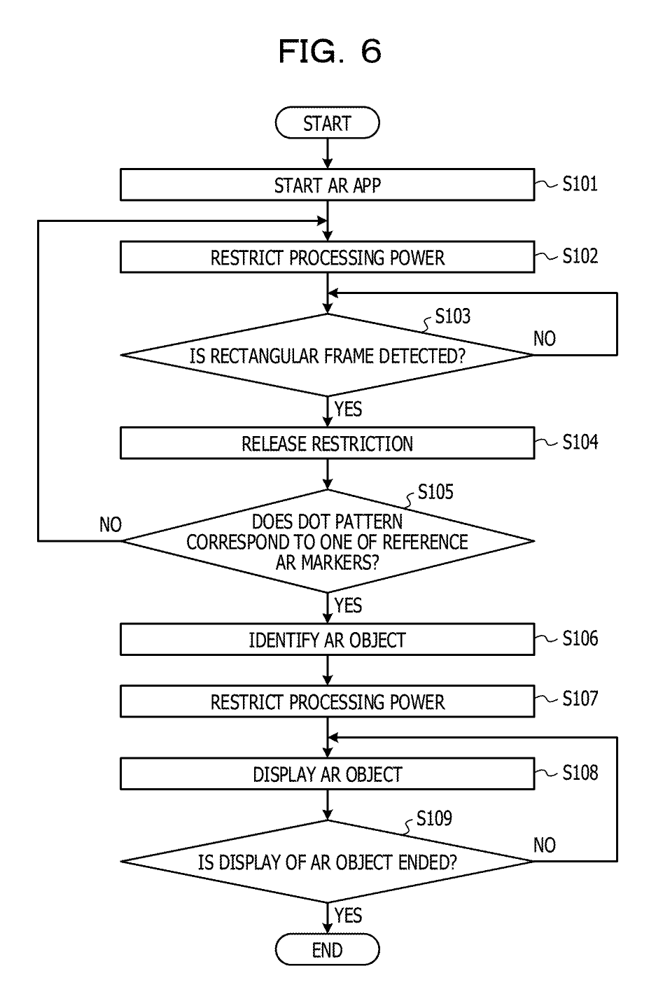

FIG. 6 illustrates an example of operation of a terminal device. The terminal device described with reference to FIG. 6 may be the terminal device 100 depicted in FIG. 1. The marker recognizing unit 151 starts an AR app (operation S101). For example, the marker recognizing unit 151 starts the AR app when receiving an instruction that requests a start of the AR app from an input unit (for example, the touch panel 100H). When the AR app is started, the imaging unit 110 starts imaging the inside of the imaging region, and the marker recognizing unit 151 displays the imaged image on the display unit 120. The AR app is application software implementing AR.

When the processing of operation S101 is completed, the CPU control unit 152 restricts the processing power of the control unit 150 (operation S102). For example, the CPU control unit 152 restricts the processing power of the control unit 150 by receiving a decreasing instruction output by the marker recognizing unit 151 after the marker recognizing unit 151 starts the AR app. Thus, although the processing power of the control unit 150 is not restricted immediately after the AR app is started, the processing power of the control unit 150 is restricted when the marker recognizing unit 151 outputs a decreasing instruction and the CPU control unit 152 receives the decreasing instruction. Power consumed by the terminal device 100 is thereby reduced.

When operation S102 is completed, the marker recognizing unit 151 determines whether or not a rectangular frame 11 is detected (operation S103). For example, the marker recognizing unit 151 obtains an imaged image from the imaging unit 110 that has started imaging, and determines whether or not a rectangular frame 11 is included in the imaged image. Operation S103 merely detects a rectangular frame 11, and therefore involves a low processing load. Thus, operation S103 is performed without delay even when the processing power of the control unit 150 is restricted.

The marker recognizing unit 151 waits until detecting a rectangular frame 11 (operation S103: NO). For example, a state in which the AR app is started is maintained, and the marker recognizing unit 151 continues displaying the imaged image. When the marker recognizing unit 151 detects a rectangular frame 11 (operation S103: YES), the CPU control unit 152 releases the restriction of the processing power of the control unit 150 (operation S104). For example, the CPU control unit 152 releases the restriction of the processing power of the control unit 150 by receiving an increasing instruction output by the marker recognizing unit 151 after the marker recognizing unit 151 detects the rectangular frame 11.

When operation S104 is completed, the marker recognizing unit 151 determines whether or not a dot pattern 13 present inside the detected rectangular frame 11 corresponds to one of the reference AR markers (operation S105). For example, the marker recognizing unit 151 performs image recognition for the dot pattern 13 present inside the detected rectangular frame 11, refers to the reference marker storage unit 130 (see FIG. 4), and determines whether or not the dot pattern 13 corresponds to one of the reference AR markers. In operation S105, the marker recognizing unit 151 performs image recognition, which involves a high processing load. If the image recognition is performed without restriction of the processing power of the control unit 150 being released, for example, the processing may not be performed smoothly. However, when the restriction of the processing power of the control unit 150 is released and image recognition is performed, a processing time is shortened as compared with a state in which the processing power remains restricted, and also heat generation of the control unit 150 is suppressed.

When the dot pattern 13 does not correspond to any of the reference AR markers (operation S105: NO), the marker recognizing unit 151 returns to operation S102. For example, the CPU control unit 152 restricts the processing power of the control unit 150 again. When the dot pattern 13 corresponds to one of the reference AR markers (operation S105: YES), the marker recognizing unit 151 identifies an AR object (operation S106). For example, the marker recognizing unit 151 refers to the AR object storage unit 140 (see FIG. 5) based on the reference AR marker corresponding to the dot pattern 13, and identifies the AR object associated with the reference AR marker. When the dot pattern 13 corresponds to the reference AR marker having a marker ID “M001,” for example, the marker recognizing unit 151 identifies character contents as the AR object.

When operation S106 is completed, the CPU control unit 152 restricts the processing power of the control unit 150 (operation S107). For example, the CPU control unit 152 restricts the processing power of the control unit 150 by receiving a decreasing instruction output by the marker recognizing unit 151 after the marker recognizing unit 151 identifies the AR object.

When operation S107 is completed, the marker recognizing unit 151 displays the AR object (operation S108). For example, the marker recognizing unit 151 dynamically displays the AR object identified in operation S106 on the display unit 120. Thus, the AR object appears in the imaged image on the display unit 120. In the case where the AR object displayed on the display unit 120 is character contents, for example, there is a low display load. The AR object is therefore displayed without delay even when the CPU control unit 152 restricts the processing power of the control unit 150 before the AR object is displayed.

When operation S108 is completed, the marker recognizing unit 151 determines whether or not the display of the AR object is ended (operation S109). For example, the marker recognizing unit 151 determines whether or not the display of the AR object is ended based on whether or not a given display time has passed or whether or not there is an instruction output from the input unit not illustrated.

When the given display time has not passed, or when no instruction is output from the input unit, the marker recognizing unit 151 determines that the display of the AR object is not ended (operation S109: NO), and returns to operation S108. For example, the marker recognizing unit 151 continues displaying the AR object on the display unit 120. When the display time has passed, or when an instruction is output from the input unit, the marker recognizing unit 151 determines that the display of the AR object is ended (operation S109: YES), and ends the processing.

The control unit 150 includes the marker recognizing unit 151 and the CPU control unit 152. When the marker recognizing unit 151 obtains an imaged image, the marker recognizing unit 151 makes a first determination of whether or not a rectangular frame 11 is included in the imaged image. When a rectangular frame 11 is included, the marker recognizing unit 151 outputs an increasing instruction to increase the processing power of the control unit 150 to the CPU control unit 152 before making a determination of whether or not a reference AR marker corresponding to a dot pattern 13 is included. The processing power of the control unit 150 is thus increased before a start of a determination involving high-load processing such as image recognition.

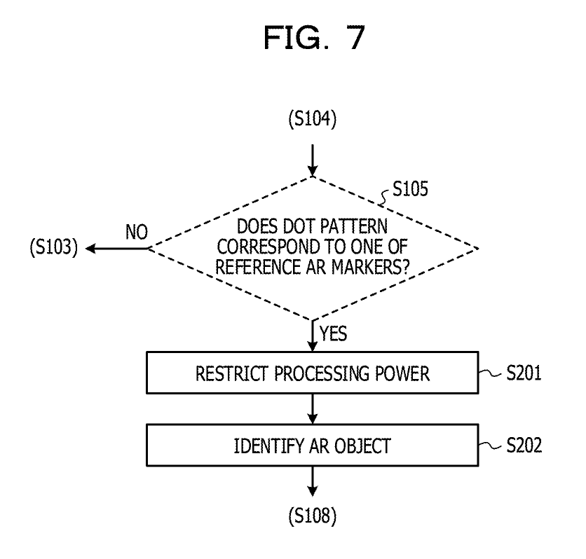

FIG. 7 illustrates an example of operation of a terminal device. The terminal device described with reference to FIG. 7 may be the terminal device 100 depicted in FIG. 1. In the flowchart of FIG. 7, parts which overlap parts in the flowchart of FIG. 6 are omitted.

When the dot pattern 13 corresponds to one of the reference AR markers (step S105: YES), the CPU control unit 152 restricts the processing power of the control unit 150 (operation S201). For example, when completing determining that the dot pattern 13 corresponds to one of the reference AR markers, the marker recognizing unit 151 outputs a decreasing instruction. By receiving the decreasing instruction, the CPU control unit 152 restricts the processing power of the control unit 150.

When operation S201 is completed, the marker recognizing unit 151 identifies an AR object (operation S202). In FIG. 7, for example, the processing order of operation S106 and operation S107 illustrated in FIG. 6 is reversed.

The processing power of the control unit 150 is increased before a start of a determination involving high-load processing such as image recognition. The processing power of the control unit 150 is decreased after this determination is completed and before the AR object is identified. For example, when the AR object is identified, the processing power of the control unit 150 is increased in FIG. 6, but the processing power of the control unit 150 is decreased in FIG. 7. Hence, in FIG. 7, power consumed when the AR object is identified may be reduced more than by the method illustrated in FIG. 6.

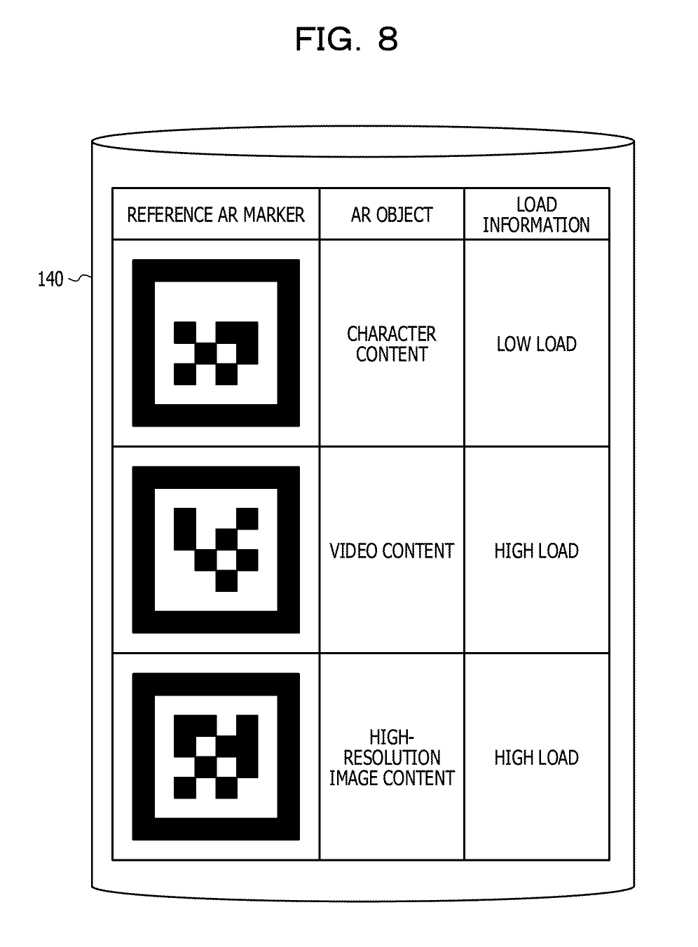

FIG. 8 illustrates an example of an AR object storage unit. The AR object storage unit depicted in FIG. 8 may be the AR object storage unit 140 depicted in FIG. 3. As illustrated in FIG. 8, the AR object storage unit 140 stores a plurality of reference AR markers in association with respective AR objects and load information. The load information is information about loads imposed when the AR objects associated with the load information are displayed.

When character contents as an AR object are displayed, for example, a load imposed is often not very high. Thus, a low load is associated as load information with the character contents in advance. On the other hand, when video contents as an AR object are displayed, a load imposed is often quite high. Thus, a high load is associated as load information with the video contents in advance. High-resolution image contents are also associated in a similar manner to the video contents. Whether the load is a low load or a high load may be determined according to a type of the AR object, or may be determined based on a threshold value in accordance with design, an experiment, or the like.

When an amount of characters of character contents is large, a high load may be associated with the character contents. When video contents, for example, are video contents having a small amount of information such as a monochrome moving image, a low load may be associated with the video contents. When either a high load or a low load is used without both a high load and a low load being used, and nothing is registered as the load information (NULL information is registered), for example, the AR object may be a high load or a low load.

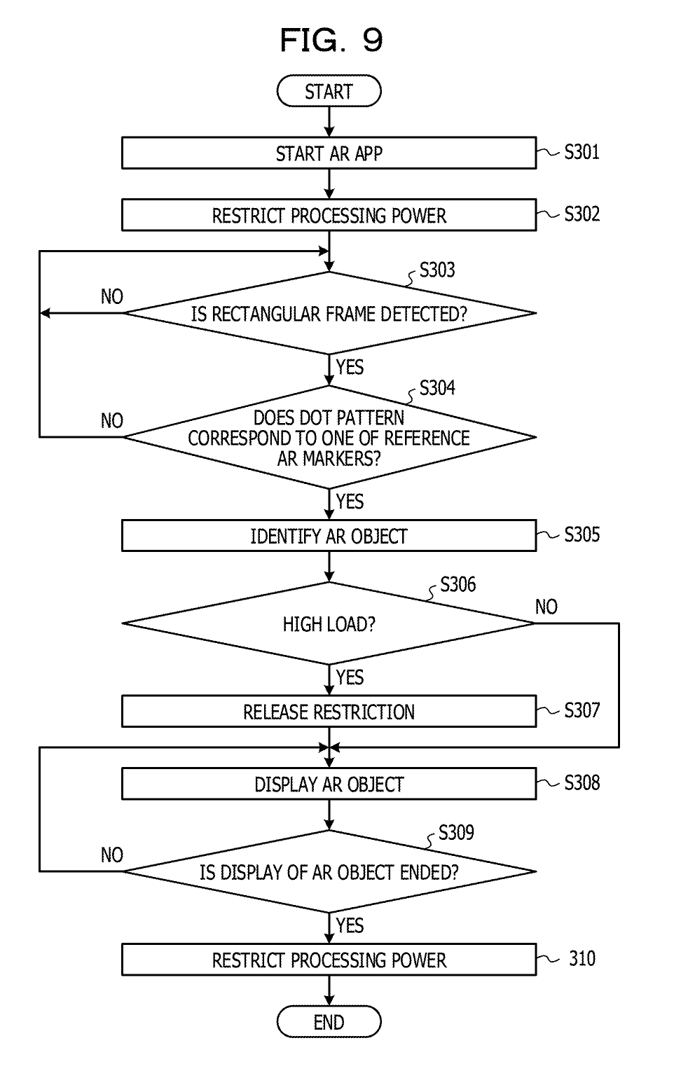

FIG. 9 illustrates an example of operation of a terminal device. The terminal device described with reference to FIG. 9 may be the terminal device 100 depicted in FIG. 1. The marker recognizing unit 151 starts the AR application (operation S301). When the AR application is started, the imaging unit 110 starts imaging the inside of the imaging region, and the marker recognizing unit 151 displays the imaged image on the display unit 120. When operation S301 is completed, the CPU control unit 152 restricts the processing power of the control unit 150 (operation S302).

When operation S302 is completed, the marker recognizing unit 151 determines whether or not a rectangular frame 11 is detected (operation S303). The marker recognizing unit 151 waits until detecting a rectangular frame 11 (operation S303: NO). When the marker recognizing unit 151 detects a rectangular frame 11 (operation S303: YES), the marker recognizing unit 151 determines whether or not a dot pattern 13 present inside the detected rectangular frame 11 corresponds to one of the reference AR markers (step S304).

When the dot pattern 13 does not correspond to any of the reference AR markers (operation S304: NO), the marker recognizing unit 151 returns to operation S303. For example, the marker recognizing unit 151 determines again whether or not a rectangular frame 11 is detected. When the dot pattern 13 corresponds to one of the reference AR markers (operation S304: YES), on the other hand, the marker recognizing unit 151 identifies an AR object (operation S305).

When operation S305 is completed, the marker recognizing unit 151 determines whether or not the identified AR object is a high load (operation S306). For example, the marker recognizing unit 151 refers to the AR object storage unit 140 (see FIG. 8) based on the identified AR object, and determines the load information associated with the AR object. For example, when the identified AR object is video contents, a high load is associated as load information with the video contents. The marker recognizing unit 151 therefore determines that the AR object is a high load. When the identified AR object is character contents, for example, a low load is associated as load information with the character contents. The marker recognizing unit 151 therefore determines that the AR object is a low load.

When the AR object is a high load (operation S306: YES), the CPU control unit 152 releases the restriction of the processing power of the control unit 150 (operation S307). For example, the CPU control unit 152 releases the restriction of the processing power of the control unit 150 by receiving an increasing instruction output by the marker recognizing unit 151 after the marker recognizing unit 151 determines that the AR object is a high load. When the AR object is a low load (operation S306: NO), operation S307 is skipped.

When operation S307 is completed, or when the AR object is a low load, the marker recognizing unit 151 next displays the AR object (operation S308). For example, the marker recognizing unit 151 dynamically displays the AR object identified in operation S305 on the display unit 120. When the AR object displayed on the display unit 120 is video contents, for example, there is a high display load. Therefore, the CPU control unit 152 increases the processing power of the control unit 150 before the AR object is displayed. The AR object is thereby displayed smoothly. The AR object operates smoothly in a case where the AR object is a moving image of a character moving left and right continuously, for example.

When the AR object displayed on the display unit 120 is character contents, there is a low display load. Therefore, the AR object is displayed without delay even when the CPU control unit 152 does not increase the processing power of the control unit 150 before the AR object is displayed.

When operation S308 is completed, the marker recognizing unit 151 determines whether or not the display of the AR object is ended (operation S309). When the marker recognizing unit 151 determines that the display of the AR object is not ended (operation S309: NO), the marker recognizing unit 151 returns to operation S308. When the marker recognizing unit 151 determines that the display of the AR object is ended (operation S309: YES), on the other hand, the CPU control unit 152 restricts the processing power of the control unit 150 (operation S310). For example, the CPU control unit 152 restricts the processing power of the control unit 150 by receiving a decreasing instruction output by the marker recognizing unit 151 after the marker recognizing unit 151 ends the display of the AR object.

The CPU control unit 152 increases the processing power of the control unit 150 immediately before the AR object imposing a high display load is displayed. The CPU control unit 152 decreases the processing power of the control unit 150 when the display of the AR object is ended. Hence, as compared with a case where the control that increases or decreases the processing power of the control unit 150 after the AR application is started is not performed at all, the AR object may be displayed smoothly while power consumed by the terminal device 100 is reduced.

For example, the CPU control unit 152 may perform operation S107 illustrated in FIG. 6 after a start of operation S109 and before an end of the processing.

While two storage units, for example, the reference marker storage unit 130 and the AR object storage unit 140 are provided, one storage unit may be provided by associating the marker IDs, the reference marker IDs, and the AR objects with one another. One storage unit may be provided by associating the marker IDs, the reference marker IDs, the AR objects, and the load information with one another. The thickness of the rectangular frame 11 may not be the same throughout, but may be partly different.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium recording a display control program which makes a processor operations of:
obtaining image information imaged by an imaging circuit;
determining whether or not a given shape is included in the obtained image information;
outputting an instruction to increase processing power of the processor when the given shape is included;
referring to a first storage configured to store a plurality of reference images, and determining whether or not the plurality of reference images include a reference image corresponding to an image inside the given shape;
when the reference image corresponding to the image inside the shape is included, referring to a second storage configured to store an object in association with the reference image, and identifying the object associated with the reference image corresponding to the image inside the shape; and
displaying the identified object on a display.

2. The non-transitory computer-readable recording medium according to claim 1, wherein an instruction to decrease the processing power is output after the object is identified.

3. The non-transitory computer-readable recording medium according to claim 1, wherein an instruction to decrease the processing power is output after completion of a determination of whether or not the reference image corresponding to the image inside the shape is included.

4. A display control device, comprising:
a storage; and
a processor coupled to the storage, the processor performs operations of:
obtaining image information imaged by an imaging circuit;
determining whether or not a shape is included in the obtained image information;
outputting an instruction to increase processing power of the processor when the shape is included;
referring to the storage configured to store a plurality of reference images, and determining whether or not the plurality of reference images include a reference image corresponding to an image inside the given shape;
when the reference image corresponding to the image inside the shape is included, referring to the storage configured to store an object in association with the reference image, and identifying the object associated with the reference image corresponding to the image inside the shape; and
displaying the identified object on a display.

5. The display control device according to claim 4, wherein an instruction to decrease the processing power is output after the object is identified.

6. The display control device according to claim 4, wherein an instruction to decrease the processing power is output after completion of a determination of whether or not the reference image corresponding to the image inside the shape is included.

7. A display control device, comprising:
a storage; and
a processor coupled to the storage, the processor performs operations of:
detecting that a reference image is included in image information imaged by an imaging circuit;
referring to the storage configured to store an object in association with the reference image, and identifying the object associated with the detected reference image;
when a display load of the identified object is higher than a reference, outputting an instruction to increase processing power of the processor; and
displaying the identified object on a display.

8. The display control device according to claim 7, wherein an instruction to decrease the processing power is output after the identified object is displayed on the display.
